(19) United States
(12) Patent Application Publication
(10) Pub. No.: US 2013/0252062 A1
(43) Pub. Date: Sep. 26, 2013

(54) SECONDARY REDOX FLOW BATTERY AND METHOD OF MAKING SAME

(71) Applicants: Howard Wilkins, Kalispell, MT (US); Ron Brost, Whitefish, MT (US); Kristine Brost, Whitefish, MT (US); Richard Bendert, Kalispell, MT (US); Paula Kosted, Kalispell, MT (US)

(72) Inventors: Howard Wilkins, Kalispell, MT (US); Ron Brost, Whitefish, MT (US); Kristine Brost, Whitefish, MT (US); Richard Bendert, Kalispell, MT (US); Paula Kosted, Kalispell, MT (US)

(73) Assignee: ZINC AIR, INC., Columbia Falls, MT (US)

(21) Appl. No.: 13/424,719

(22) Filed: Mar. 20, 2012

(51) Int. Cl. H01M 4/36; H02J 7/00; H01M 10/02

(52) U.S. Cl. 429/105; 320/127

(57) ABSTRACT

A secondary redox flow battery having a charge capacity and an efficiency includes an anode half-cell and a cathode half-cell having a fluid-containing vessel defining a cavity in which is disposed an electrode and a catholyte. The catholyte consists of a solvent, at least two cation species, and an anionic transition metal complex. The catholyte cation species are selected from the group consisting of Group I element ions, Group II element ions and ammonium ions. The battery also includes a reservoir fluidly communicating with the cavity and a separator ionically communicating between the anode half-cell and the cathode half-cell. The battery is capable of a discharge current equal to or greater than 20 milliamperes/cm².

### TECHNICAL FIELD

The present disclosure relates to a secondary redox flow battery and method of making same.

### BACKGROUND

Secondary redox flow battery systems are known in the art for their capability of storing large quantities of energy and efficiently releasing that energy upon demand. Secondary redox flow batteries suitable for storing a typical quantity of energy generated by irregularly-operating green technologies, such as wind turbines and solar panel systems, are at least an order of magnitude too large to be economically usable.

It is desirable to increase the energy density of secondary redox flow battery systems in order to meet the needs of intermittent energy sources, while improving or at least retaining the efficiency of the batteries.

### SUMMARY

A secondary redox flow battery having a charge capacity and an efficiency includes an anode half-cell and a cathode half-cell. The cathode half-cell includes a fluid-containing vessel defining a cavity in which is disposed an electrode and a catholyte. The catholyte consists of a solvent, a therein dissolved transition metal complex anion, and a cation species. The transition metal complex anion has a first electronic state and a second electronic state and is capable of oxidation and reduction between the first and second electronic states. The cation may be selected from the group consisting of Group I element ions, Group II element ions and ammonium ions. The battery also includes a reservoir fluidly communicating with the cavity and a separator ionically communicating between the anode half-cell and the cathode half-cell. The battery is capable of a discharge equal to or greater than 20 milliamperes/cm².

A secondary redox flow battery having a charge capacity and an efficiency has an anode half-cell and a cathode half-cell including a fluid-containing vessel defining a cavity in which is disposed an electrode and an catholyte having at least two different types of cations, used in combination in certain embodiments, and an iron-containing anion capable of a redox reaction. The iron-containing anion is present in an amount ranging from 20 relative percent to 55 relative percent more than the amount present when only one species of cation is present.

The method of making a secondary redox flow battery having a charge capacity and an efficiency includes the step of providing an anode half-cell, a cathode half-cell, and an ionically-conductive separator between them. The cathode half-cell includes a reservoir and a reaction chamber having an electrode and a catholyte that includes a transition metal complex anion capable of oxidation and reduction, and a cation selected from the group consisting of Group I element ions, Group II element ions and ammonium ions. An electrical load is applied between the anode half-cell and the cathode half-cell to form a secondary redox flow battery. The electrical current of the battery increases with no gain in cell polarization when the solubility of the transition metal complex anion is increased by changing the composition of the catholyte such that the relative concentration of the cations in a mixture cooperate through a reduced common ion effect, relative to an uncooperative system where a single species of cation promotes the precipitation of the transition metal complex anion through the same common ion effect.

### BRIEF DESCRIPTION OF THE DRAWINGS

FIG. 1 illustrates an schematic representation of the secondary redox flow battery according to at least one embodiment; and

FIG. 2 diagrammatically illustrates a process of use of a secondary redox flow battery according to at least one embodiment.

### DETAILED DESCRIPTION

Reference will now be made in detail to presently preferred compositions, embodiments and methods of the present invention, which constitute the best modes of practicing the invention presently known to the inventors. The figures are not necessarily to scale. However, it is to be understood that the disclosed embodiments are merely exemplary of the invention that may be embodied in various and alternative forms. Therefore, specific details disclosed herein are not to be interpreted as limiting, but merely as a representative basis for any claims and/or as a representative basis for teaching one skilled in the art to variously employ the present invention.

Except in examples, or where otherwise expressly indicated, all numerical quantities in this description used to indicate amounts of material or dimensions are to be understood as modified by the word “about” in describing the broadest scope of the invention. Practice within the numerical limits stated is generally preferred. Also, unless expressly stated to the contrary: the description of a group or class of materials as suitable or preferred for a given purpose in connection with the invention implies that mixtures of any two or more the members of the group or class are equally suitable for preferred; the first definition of an acronym or other abbreviation applies to all subsequent uses herein of the same abbreviation and applies mutatis mutandis to normal grammatical variations of the initially defined abbreviation; and, unless expressly stated to the contrary, measurement of a property is determined by the same technique as previously or later referenced for the same property. Also, unless expressly stated to the contrary, percentage, “parts of,” and ratio values are by weight, and the term “polymer” includes “oligomer,” “copolymer,” “terpolymer,” “pre-polymer,” and the like.

The relatively low solubility of transition metal complex salts in conventional electrolytes, such as sodium hydroxide, limit their effectiveness in flow cells to systems using a higher temperature catholyte. Use of higher temperature systems reduces the efficiency of the flow cell through energy loss to the environment. Use of higher temperature systems to limit the possibility of increased electrolyte precipitation also imposes severe design constraints that are required to limit decomposition of transition metal complex anions. The decomposition of the transition metal complex anions is undesirable since decomposition products foul a flow cell 12.

Exemplary flow cell structures are disclosed in U.S. patent application Ser. No. 13/102,566, which is incorporated in its entirety by reference. When flow cells are ganged in sequence, they may form an exemplary flow cell battery such as disclosed in U.S. patent application Ser. No. 13/196,493, which is incorporated in its entirety by reference.

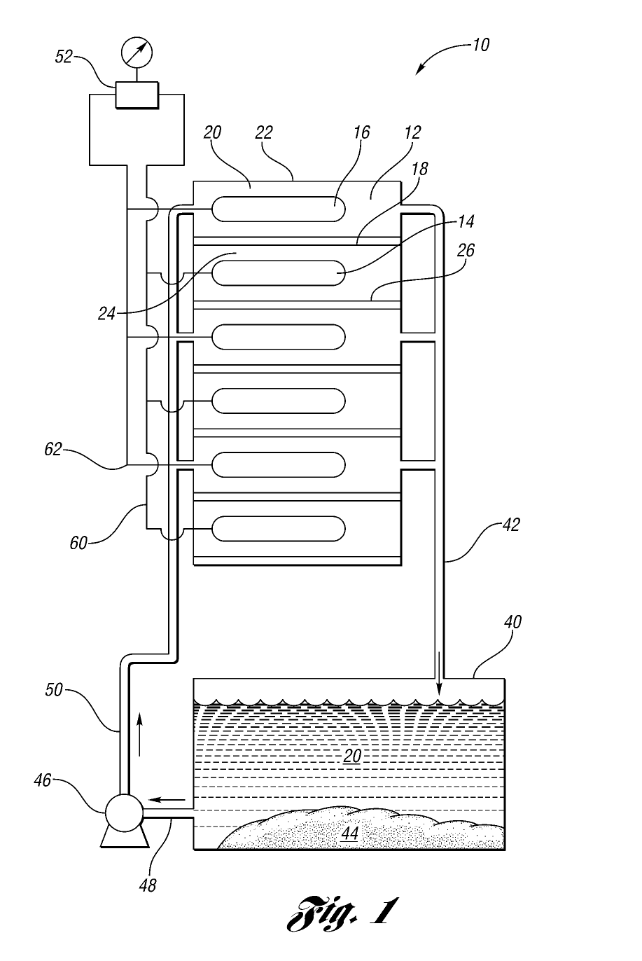

Turning now to FIG. 1, a secondary flow redox battery 10 is schematically illustrated according to at least one embodiment. Battery 10 includes a plurality of flow cells 12. Flow cell 12 includes an anode half-cell including an electrode 14, and a cathode half-cell including an electrode 16, with a separator, such as membrane 18, disposed therebetween. Membrane 18 may include an ion permeable membrane, a polymeric membrane, such as a porous polytetrafluoroethylene (PTFE)-based membrane, or other suitable membrane known in the art. Flow cell 12 further includes in the cathode half-cell, a catholyte 20 as a solution that is contained by a vessel 22. Catholyte 20 is disposed completely or partially around electrode 16. Flow cell 12 also includes in the anode half-cell an anolyte 24 contained by a vessel 26. Anolyte 24 is disposed completely or partially around electrode 14.

Circulating of catholyte 20 allows transference of a solid 44 from reservoir 40 to vessel 22 based on the solubilization of solid 44. Circulating of catholyte 20 also reduces any chemical polarization between electrode 16 and catholyte 20 due, in part, to limiting the formation of a dielectric layer between electrode 16 and catholyte 20 thereby increasing the efficiency of battery 10. Catholyte 20 circulates from vessel 22 to a reservoir 40 through conduit 42. In at least one embodiment, catholyte 20 precipitates solids 44. Catholyte 20 further circulates from reservoir 40 to a pump 46 through a conduit 48. Pump 46 further circulates catholyte 20 back to vessel 22 through a conduit 50. It should be understood that pump 46 may be disposed at any suitable point along the conduits.

Electrode 14 is electrically connected to a device 52 by a connector 60. Device 52, in at least one embodiment, is an electrical load. In another embodiment, device 52 is an electrical charging device. Electrode 16 is electrically connected, also, to device 52 by a connector 62.

Catholyte 20 includes a redox couple composition. The redox couple composition, in at least one embodiment, includes a transition metal complex anion, such as anionic complexes of Fe²⁺/Fe³⁺. A non-limiting example of the Fe²⁺/Fe³⁺ salt from which the anionic complex arises includes iron hexacyanide. The transition metal complex anion includes a transition metal having at least two electronic states. The transition metal complex anion is capable of undergoing oxidation and reduction between the two electronic states, thus storing electrical charge. In at least one embodiment, the transition metal complex includes a ferrocyanide/ferricyanide anion. Other non-limiting examples of redox couple compositions include anionic complexes of cerium, such as Ce³⁺/Ce⁴⁺; titanium, such as Ti³⁺/Ti⁴⁺; and vanadium cations. Such transition metal complexes are often capable of forming a precipitate of large agglomerated crystalline particles, each particle having sizes of greater than 4 mm in certain embodiments, and may also form solid masses of crystals of larger size, in another embodiment.

Catholyte 20 further includes a dissolved cation. In at least one embodiment, the cation, either before dissolution or after dissolution, includes at least one metal cation selected from the group consisting of Group I element ions, Group II element ions and ammonium ions. In another embodiment, the cation includes a sodium cation. In another embodiment, the cation includes a potassium cation. In yet another embodiment, a mixture of cations includes sodium cations and potassium cations. In yet another embodiment, a mixture may include two or more cations, or in certain embodiments, three or more cations. It should further be understood that other cations may be used. Non-limiting examples of such cations include lithium cations, calcium cations, magnesium cations, rubidium cations, strontium cations, and substituted ammonium cations.

In at least one embodiment, sodium cations are present in catholyte 20 in an amount ranging from 0.05 molar to 3.4 molar. In another embodiment, sodium cations are present in catholyte 20 in an amount ranging from 0.5 molar to 2.5 molar.

In at least one embodiment, potassium cations are present in the catholyte 20 in an amount ranging from 0.05 molar to 3.4 molar. In another embodiment, potassium cations are present in catholyte 20 in an amount ranging from 0.5 molar to 2.5 molar.

Flow cell performance is particularly sensitive to the dissolved concentration of active materials such as transition metal anion complexes, such as iron-containing anions, including ferrocyanide/ferricyanide anions prepared from cyanide compounds. In at least one embodiment, the total amount of sodium iron hexacyanide ranges from 0.05 molar to 0.95 molar. In another embodiment, the total amount of sodium iron hexacyanide ranges from 0.25 molar to 0.90 molar. In yet another embodiment, the total amount of sodium iron hexacyanide ranges from 0.3 molar to 0.85 molar. In yet another embodiment, the amount of sodium iron hexacyanide ranges from 0.35 molar to 0.80 molar.

In at least one embodiment, the amount of potassium iron hexacyanide ranges from 0.05 molar to 0.95 molar. In another embodiment, the amount of potassium iron hexacyanide ranges from 0.25 molar to 0.90 molar. In yet another embodiment, the amount of potassium iron hexacyanide ranges from 0.3 molar to 0.85 molar. In yet another embodiment, the amount of potassium iron hexacyanide ranges from 0.35 molar to 0.80 molar.

In at least one embodiment, the total amount of ferrocyanide/ferricyanide anion ranges from 0.05 molar to 0.95 molar. In another embodiment, the total amount of ferrocyanide/ferricyanide anion ranges from 0.25 molar to 0.90 molar. In yet another embodiment, the total amount of ferrocyanide/ferricyanide anion ranges from 0.3 molar to 0.85 molar. In yet another embodiment, the total amount of ferrocyanide/ferricyanide anion ranges from 0.35 molar to 0.80 molar.

In at least one embodiment, the total increase in the concentration of ferrocyanide/ferricyanide anion in catholyte 20 ranges from 5 relative percent to 70 relative percent when solubilized in catholyte 20 having at least two different cations relative to a solution having a single type of cation. In another embodiment, the total increase in the amount of ferrocyanide/ferricyanide anion in catholyte 20 ranges from 20 relative percent to 55 relative percent when solubilized in electrolyte in catholyte 20 having at least two different cations relative to a solution having a single type of cation. In another embodiment, the total increase in the amount of ferrocyanide/ferricyanide anion in catholyte 20 ranges from 30 relative percent to 45 relative percent when solubilized in electrolyte in catholyte 20 having at least two different cations relative to a solution having a single type of cation. While not wishing to be bound by any one particular theory, the increase in the amount of solubilized ferrocyanide/ferricyanide anion may reflect, in part, a common ion effect.

Surprisingly, a hybrid of mixed cation catholytes with the ferrocyanide/ferricyanide redox couple composition, including a Fe²⁺/Fe³⁺ redox couple, results in advantageous conditions such as a high charge capacity density, low operating temperature, reduced volume of reservoir 40 and, hence, size of the flow battery, as well as increased efficiency, relative to a battery that has a less soluble form of the transition metal complex anion, without precipitation or decomposition of the transition metal complex anion. Also surprisingly, solids 44 forms a flowing and finely divided transition metal complex solid with particle sizes less than 1 mm when compared to massive crystalline formations that have precipitated in ferricyanide anionic systems in electrolytic cells where only one cation type is present. Metal salts have particle sizes in excess of 4 mm may be agglomerated, which typically leads to clogging of pumps, pipes, and other battery structures. Formation of the relatively small ferrocyanide/ferricyanide crystals in certain embodiments of battery 10, also surprisingly, does not require the use of a nitrogen blanket or other oxygen scavenger needed in previous electrolytic cells that use ferrocyanide/ferricyanide anionic systems in order to prevent the decomposition of the ferricyanide anions.

Electrolytes in catholyte 20 include, in certain embodiments, hydroxide anions. In at least one embodiment, the concentration of hydroxide anions in catholyte 20 ranges from 0.001 molar to 6 molar. In at least one embodiment, the concentration of hydroxide anions in catholyte 20 ranges from 0.001 molar to 3 molar. In another embodiment, the concentration of hydroxide anions in catholyte 20 ranges from 0.005 molar to 5 molar. In yet another embodiment, the concentration of hydroxide anions in catholyte 20 ranges from 1 molar to 6 molar.

In at least one embodiment, electrode 14 comprises a porous zinc layer plated on a conducting surface such as non-porous zinc in order to take advantage of the relatively high charge density of zinc associated with zinc's simultaneous properties of lower atomic weight, high oxidation state, high oxidation potential, and high mass density. Anodes of other suitable compositions known in the art may be used in certain embodiments.

In at least one embodiment, electrode 16 comprises an inert and non-gassing cathode, such as a nickel plate. Cathodes of other suitable compositions known in the art may be used in certain embodiments.

In at least one embodiment, the secondary redox flow battery 10 is capable of generating a discharge current ranging greater than 20 milliamperes/cm². In another embodiment, the secondary redox flow battery 10 is capable of generating a discharge current ranging from 20 milliamperes/cm² to 120 milliamperes/cm². In another embodiment, the secondary redox flow battery 10 is capable of generating a discharge current ranging from 25 milliamperes/cm² to 60 milliamperes/cm².

In at least one embodiment, the secondary redox flow battery 10 is capable of generating an increased discharge current ranging from 5 relative percent to 90 relative percent compared to a secondary redox flow battery having a concentration of transition metal complex anion that is not enhanced by having at least two cations present in the catholyte 20. In another embodiment, the secondary redox flow battery 10 is capable of generating an increased discharge current ranging from 20 relative percent to 60 relative percent compared to a secondary redox flow battery having a concentration of transition metal complex anion that is not enhanced by having at least two species of cations present in the electrolyte.

In at least one embodiment, the secondary redox flow battery 10 is capable of accepting an electrical charge at a voltage greater than 1.86 V. In another embodiment, the secondary redox flow battery 10 is capable of accepting electrical charge at a voltage between 1.87 V and 2.1 V. In yet another embodiment, the secondary redox flow battery 10 is capable of accepting an electrical charge at a voltage between 1.9 V and 2 V.

In at least one embodiment, the secondary redox flow battery 10 is capable of inhibiting formation of either oxygen gas at electrode 16 or hydrogen gas at electrode 14 during charge. In another embodiment, the secondary redox flow battery 10 is capable of inhibiting formation of either oxygen gas at electrode 16 or hydrogen gas at electrode 14 during charge, such that less than one weight percent of the catholyte 20 is converted to gas that is evolved over the lifetime of the cell.

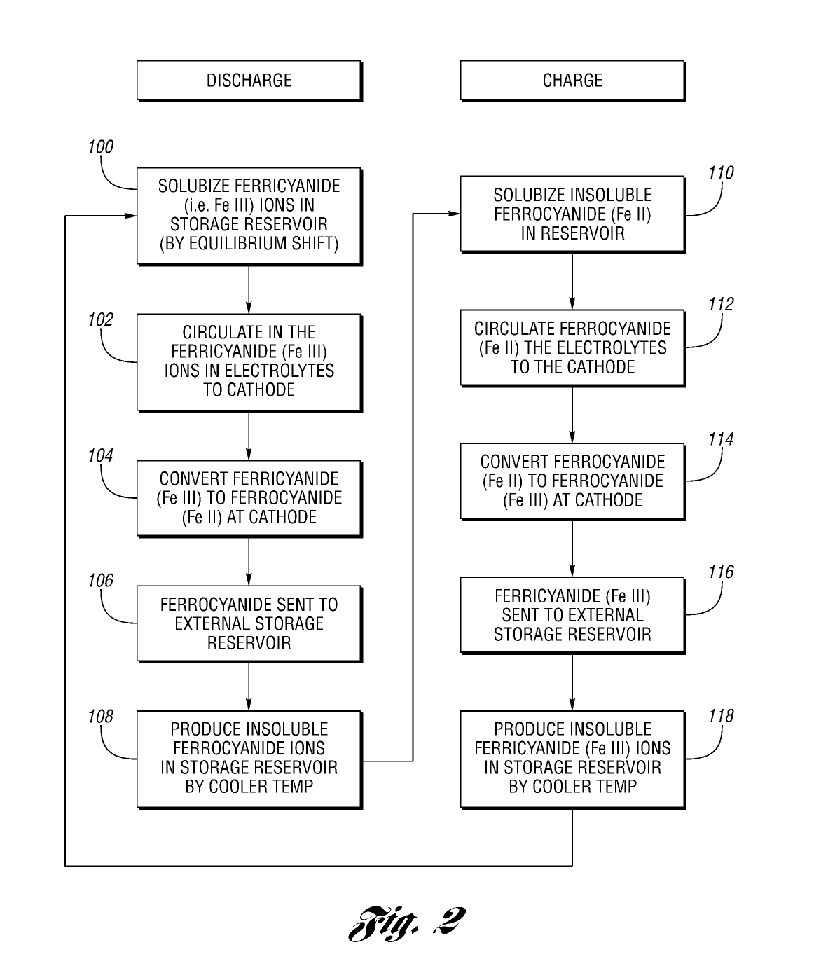

Turning now to FIG. 2, a process of use of a secondary redox flow battery is illustrated diagrammatically according to at least one embodiment. During a discharge operation of the battery step 100 includes solubilizing ferricyanide anions in solid 44 in reservoir 40 by an equilibrium shift of the amount of ferricyanide anions of catholyte 20 as they are converted to ferrocyanide anions at electrode 16. The solubilized ferricyanide anions circulate in catholyte 20 to vessel 22 in step 102. In step 104, the ferricyanide anions are reduced to ferrocyanide anions at electrode 16. In step 106, the ferrocyanide anions circulate from vessel 22 to reservoir 40 where the ferrocyanide anions may precipitate to form solid 44 over time in step 108.

In at least one embodiment, catholyte 20 circulates at a rate so as to include the catholyte flow having a turnover ratio ranging from 0.04 to 4 per hour. In at least one embodiment, catholyte 20 circulates at a rate so as to include the catholyte flow having a turnover ratio ranging from 0.5 to 2 per hour.

In at least one embodiment, catholyte 20 has a maximum temperature that is equal to or less than 50° C. In another embodiment, catholyte 20 has a maximum temperature in a range from 5° C. to 40° C. In yet another embodiment, catholyte 20 has a maximum temperature in a range from 15° C. to 30° C.

In at least one embodiment, catholyte 20 in reservoir 40 has a temperature equal to or less than catholyte 20 in vessel 22. In another embodiment, catholyte 20 in reservoir 40 has a temperature within a range from 2° C. to 5° C. less than a temperature of catholyte 20 in vessel 22. In another embodiment, catholyte 20 in reservoir 40 has a temperature within a range from 10° C. to 5° C. less than a temperature of catholyte 20 in vessel 22.

During a charging operation, in step 110, ferrocyanide anions in solid 44 are solubilized by an equilibrium shift of the amount of ferrocyanide anions in catholyte 20 as they are converted to ferricyanide anions at electrode 16. In step 112, ferrocyanide anions in catholyte 20 circulate to vessel 22. In step 114, ferrocyanide anions are oxidized to ferricyanide anions at electrode 16. Ferricyanide anions circulate to reservoir 40 in step 116. In step 118 ferricyanide anions precipitate in reservoir 40 to form solid 44.

In at least one embodiment, a method of using a secondary redox flow battery 10 includes the steps of providing an anode half-cell, a cathode half-cell, and an ionically-conductive separator situated therebetween. The cathode half-cell includes reservoir 40 and a reaction chamber, such as vessel 22, having electrode 16 and catholyte 20 that includes a transition metal complex anion capable of oxidation and reduction, and cations. The catholyte 20 has at least two different cations selected from Group I element ions, Group II element ions and ammonium ions. The catholyte 20 may include hydroxide anion.

An electrical load or an electrical charging condition is applied between the anode half-cell and the cathode half-cell to form a secondary redox flow battery 10. The electrical current density of the battery increases when the solubility of the metallic salt anion is maximized by adjusting the composition of the catholyte 20 such that the concentration of the first cation cooperates, possibly, in part, through a reduced common ion effect with respect to the concentrations of the other cations. The cooperative effect is relative to an uncooperative system where the only one species of cation is present.

In at least one embodiment, the efficiency of the secondary redox flow battery 10 is increased when the catholyte 20 includes at least two cations, relative to a catholyte including only one species of counter cation.

All exemplary embodiments are described above, it is not intended that these embodiments describe all possible forms of the invention. Rather, the words used in the specification awards a description rather than limitation, and it is understood that various changes may be made without departing from the spirit and scope of the invention. Additionally, the features of the various implementing embodiments may be combined to form further embodiments of the invention.

1. A secondary redox flow battery having a charge capacity and an efficiency, the battery comprising:
a plurality of flow cells electrically connected to each other, each flow cell including an anode half-cell and a cathode half-cell, the cathode half-cell including a fluid-containing vessel defining a cavity in which is disposed an electrode and a circulating catholyte solution including a transition metal complex anion and at least two cation species, the transition metal complex anion having a first electronic state and a second electronic state, the transition metal complex anion being capable of oxidation and reduction between the first and second electronic states, the cation species being selected from the group consisting of Group I element ions, Group II element ions, and ammonium ions, the transition metal complex forming flowing and finely divided solids with particle sizes less than 1 mm;
a reservoir fluidly communicating with the cavity; and
a separator ionically communicating between the anode half-cell and the cathode half-cell, the battery being capable of a discharge current rate equal to or greater than 20 milliamperes/cm².

2. The battery of claim 1, wherein the transition metal complex anion is present in the catholyte in an amount ranging from 5 relative percent to 70 relative percent more than the amount present when compared to a catholvte having only one cation species.

3. The battery of claim 1, wherein the battery is capable of reducing gas evolution from the cathode to less than 1 wt. % of the catholyte during a lifetime of the battery.

4. The battery of claim 1, wherein amounts of the cations in combination in the catholyte are configured to maximize a current density of the flow cell and to minimize a precipitate including the transition metal complex anion, the precipitate being present in an amount less than 5 wt. % of a total amount of the transition metal complex anion in the cathode half-cell and reservoir.

5. The battery of claim 1, wherein the transition metal complex anion has a transition metal selected from the group consisting of iron, cerium, titanium, and vanadium.

6. The battery of claim 5, wherein the transition metal complex anion is an iron hexacyanide is present in an amount ranging from 0.05 molar iron hexacyanide to 0.95 molar iron hexacyanide.

7. The battery of claim 1, wherein the cation of the transition metal complex anion includes at least one cation species selected from the group consisting of a sodium cation and a potassium cation.

8. The battery of claim 1, wherein the catholyte includes hydroxide anions.

9. The battery of claim 8, wherein hydroxide anions are present in an amount ranging from 0.001 molar to 6 molar.

10. The battery of claim 1, wherein the cations of the catholyte include at least one cation species selected from the group consisting of a sodium cation and a potassium cation.

11. The battery of claim 10, wherein the sodium cations of the catholyte are present in an amount ranging from 0.05 molar to 3.4 molar and the potassium cation of the catholyte is present in an amount ranging from 0.05 molar to 3.4 molar.

12. (canceled)

13. A secondary redox flow battery having a charge capacity and an efficiency, the battery comprising:
an anode half-cell; and
a cathode half-cell including a fluid-containing vessel defining a cavity in which is disposed an electrode and a circulating catholyte solution including at least two cation species of the catholyte that are each present in an amount ranging from 0.05 molar to 3.4 molar and an iron-containing anion capable of a redox reaction, being present when a hydroxide anion is present in a range of 1 molar to 6 molar, in an amount ranging from 20 relative percent to 55 relative percent more than amount present in a catholyte having only one cation species.

14. The battery of claim 13, wherein the cation species are selected from the group consisting of Group 1 element ions, Group II element ions and ammonium ions.

15. The battery of claim 13, wherein a ratio between the amount of a first cation species of the catholyte and a second cation species is adjusted to maximize the amount of the iron-containing anion when the catholyte is at a temperature less than 50° C.

16. The battery of claim 13, wherein the iron-containing anion includes a ferrocyanide/ferricyanide redox couple anion.

17. The battery of claim 16, wherein the amount of the ferrocyanide/ferricyanide redox couple anion present in the catholyte is maximized by manipulating a common ion effect between the cation species of the catholyte.

18. The battery of claim 13, wherein the battery is capable of accepting an electrical charge between 1.87 V and 2.1 V.

19-20. (canceled)
